(19) United States
(12) Patent Application Publication
(10) Pub. No.: US 2012/0145907 A1
(43) Pub. Date: Jun. 14, 2012

(54) DYNAMIC ENVIRONMENTAL CHAMBER AND METHODS OF RADIATION ANALYSIS

(76) Inventor: August F. Koster van Groos, Oak Park, IL (US)

(21) Appl. No.: 13/294,699

(22) Filed: Nov. 11, 2011

Related U.S. Application Data
(60) Provisional application No. 61/459,494, filed on Dec. 14, 2010.

(51) Int. Cl. G01N 21/17; G01N 23/20; G01J 5/02; G01J 3/44

(52) U.S. Cl. 250/339.07; 356/301; 378/79; 250/395; 250/336.1

(57) ABSTRACT

The invention provides a high pressure dynamic environmental chamber for analysis of solids in a liquid suspension in motion at pressures ranging from vacuum to 2000 bars or more and temperatures from −50° C. to 500° C., using a liquid and/or a gas phase as pressurizing medium. The chamber is equipped with an entry window and an exit window so that the suspension can be illuminated and analyzed, using X-ray Diffraction, Raman Spectroscopy, Infrared Spectroscopy, or other photon radiation. The concept of direct analysis of a solid in suspension in motion over a wide range of pressures and temperatures is an important aspect of this invention. This motion is useful for X-ray diffraction analysis of the dispersed solid material, because it allows for a continuous change in the crystallographic orientation of the solid phase with respect to the primary X-rays while keeping the solid material in suspension.

### RELATED APPLICATIONS

This application claims the benefit under 35 U.S.C. 119(e) of U.S. Provisional Patent Application Ser. No. 61/459,494 filed Dec. 14, 2010, which is incorporated herein by reference in its entirety and made a part hereof.

### TECHNICAL FIELD

An example embodiment pertains generally to spectroscopic or radiation analysis and high-pressure and high-temperature research in simulated environmental conditions. More specifically, an example embodiment relates to an apparatus and method for X-ray crystallography of both organic and inorganic liquid suspensions, and environmental systems and structures.

### BACKGROUND

In traditional crystallographic X-ray methods, the sample being analyzed either as a single crystal or fine crystalline powder is generally mounted in stationary manner either by, for example, attaching the sample to a fiber, placing the sample in a thin glass tube, or spreading the sample onto a flat surface. These mounts may be placed in closed or partially open chambers that allow changes in temperature, i.e. high-temperature furnaces, or under pressure. In these chambers the sample may be allowed to interact with a gas other than air. Using liquids in these methods is either extremely difficult or impossible, because of the absorption/dispersion properties of virtually all liquids. In addition, many chambers have a relatively long distance through which radiation must pass through these liquid media between entry and exit of the chamber, further increasing absorption of the radiation.

### SUMMARY

According to an example embodiment an apparatus for radiation analysis of a liquid suspension in motion comprises a chamber for holding the liquid suspension; a port for admission of the liquid suspension into the chamber; and a pump or agitator to move the liquid suspension in the chamber during analysis. The movement allows radiation analysis of the solid material suspended in the liquid along different crystalline orientations as the liquid suspension moves. The apparatus further comprises a source of radiation adjacent the chamber with the chamber having one or more windows through which radiation from the radiation source may pass during radiation analysis of the liquid suspension, and a detector adjacent to the chamber.

According to further example embodiments, a chamber for radiation analysis of a liquid suspension in motion comprises an enclosable volume for holding the liquid suspension; a port for admission of the liquid suspension into the chamber; a recess for receiving a pump or agitator to move the liquid suspension in the chamber during analysis; and one or more windows through which radiation may pass during radiation analysis of the liquid suspension.

### BRIEF DESCRIPTION OF DRAWINGS

Some embodiments are illustrated by way of example and not limitation in the figures of the accompanying drawings in which:

FIG. 1 shows a schematic layout of an environmental chamber, according to an example embodiment.

FIG. 2 shows a schematic path of an illuminating electromagnetic beam from the source through the windows of an environmental chamber to the detector, according to example embodiments.

FIG. 3 shows a front perspective view of a main unit of an environmental chamber, according to an example embodiment, with some internal detail shown in ghosted outline.

FIG. 4 shows a rear perspective view of the main unit shown in FIG. 3, again with some internal detail shown in ghosted outline.

FIG. 5 shows a rear perspective view of a base unit of an environmental chamber, according to an example embodiment, with some internal detail shown in ghosted outline.

FIG. 6 shows a cross-section of the assembled main and base units of an environmental chamber, according to an example embodiment.

FIGS. 7, 8 and 9 are flow diagrams showing methods of radiation analysis, according to example embodiments.

### DETAILED DESCRIPTION

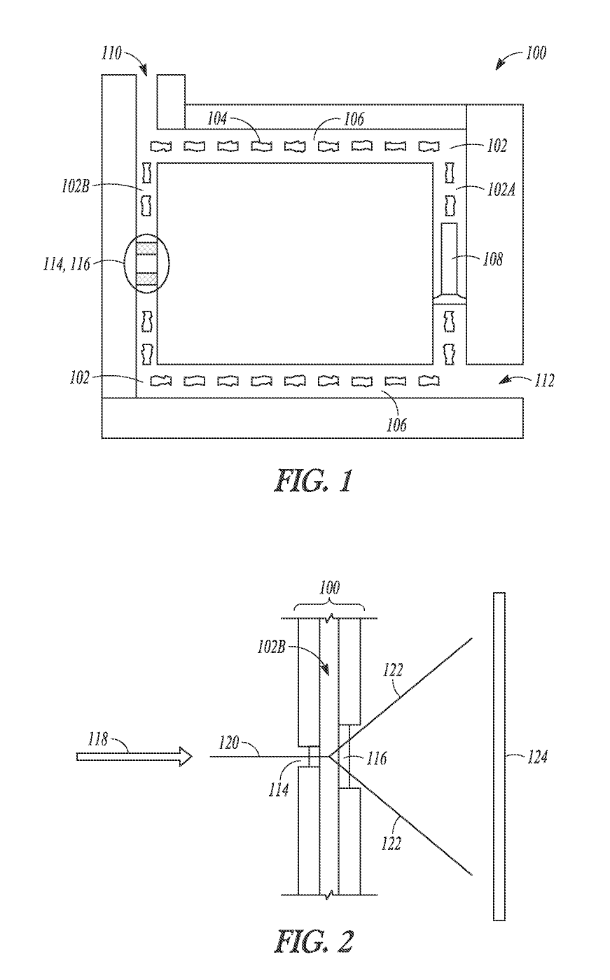

Disclosed in FIG. 1 is a schematic view of an environmental pressure chamber 100 capable of withstanding pressures to 2000 bars and temperatures from −50° C. to 500° C. in dynamic conditions. Higher pressures in excess of 2000 bar can be achieved with appropriate reinforcement of the chamber. Thicker chamber walls, stronger assembly bolts, or stronger construction materials may for example be employed when a chamber is required to withstand extreme pressure and/or temperature conditions. The chamber is designed to address many of the limitations of traditional crystallographic X-ray methods. The chamber 100 comprises a closed-circuit loop or channel 102 that may contain a solid (shown schematically by pieces 104) in suspension in a liquid suspension or dispersion 106 that is to be analyzed. The closed-circuit loop 102 has included within it an agitator or reciprocating pump 108 combined with a PEEK (polyether ether ketone) check valve (not shown) to circulate the liquid suspension 106 to ensure uniformity while maintaining the solid material 104 in suspension. The pump 108 is composed of PEEK-encased iron and is driven using two solenoids (not shown) disposed on the outside of one leg 102A of the closed-circuit loop 102. Access to the loop 102 is provided by a pressure-inlet port 110, and one or more inlet/outlet ports 112 to allow both chemical adjustment and sampling, as needed, of the liquid suspension 106 at pressure.

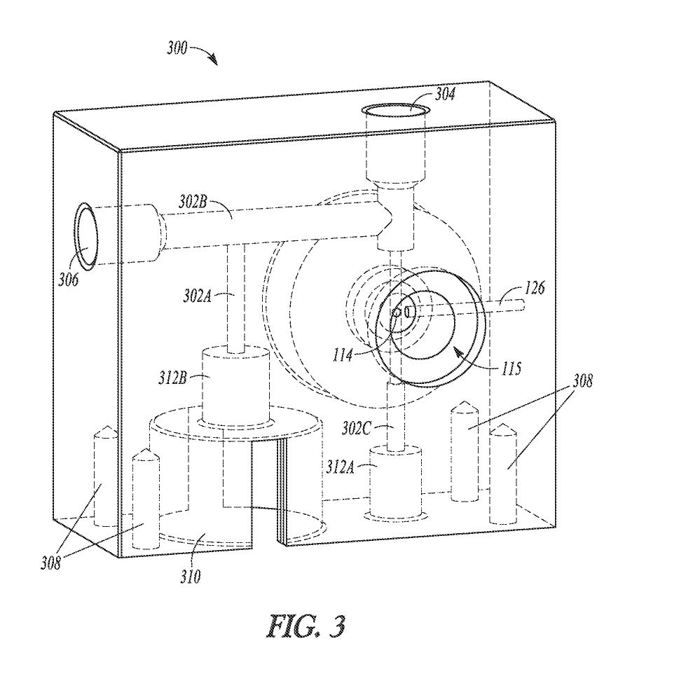

The chamber 100 is equipped with two opposed high-pressure windows 114 and 116 disposed in another leg 102B of chamber 100. These windows can be seen in sectional view in FIG. 2. One of these windows 114 is an entry window that allows the suspension to be illuminated by a collimated X-ray beam 118 or another electromagnetic beam (e.g., Raman). The second window 116 allows exit of diffracted X-rays or another modified electromagnetic beam.

The environmental chamber 100 is manufactured using materials that have a low solubility in the selected dispersing liquid suspension 106, such as stainless steel or titanium. A suitable material for the chamber when using highly corrosive alkaline suspensions is PEEK (polyether ether ketone), but the temperature range of this chamber would thus be limited to less than 200° C.

With reference to FIG. 2, the small entry window 114 accommodates and allows the passage of a thin, well-focused beam 120 from an electromagnetic source 118. The beam 120 ideally is collimated to a diameter of 0.25 mm to 0.5 mm and passes through the suspension 106 illuminating the dispersed solid 104 which allows radiation analysis of the solid material suspended in the liquid along different crystalline orientations as the liquid suspension 106 moves.

The diameter of the entry window in the present example design is 2 mm. The larger exit window 116 in the present example design has a diameter of 6 mm, which allows a wide range of angles for the refracted or diffracted beams 122. These beams are analyzed by a detector 124 located outside the environmental chamber 100. The distance between the windows 114 and 116 is small and may be adjusted from 0.25 mm to 2 mm, depending on the characteristics of the illuminating source 118 and the absorption characteristics of the windows and the liquid suspension 106. When the environmental chamber 100 is used at high pressures, the windows may be made from vapor-deposited diamond that may range in thickness to 1 mm, depending on pressure. At near-ambient conditions, the chamber may be outfitted with thin polyester film windows, which will perform satisfactorily, and which have low absorption.

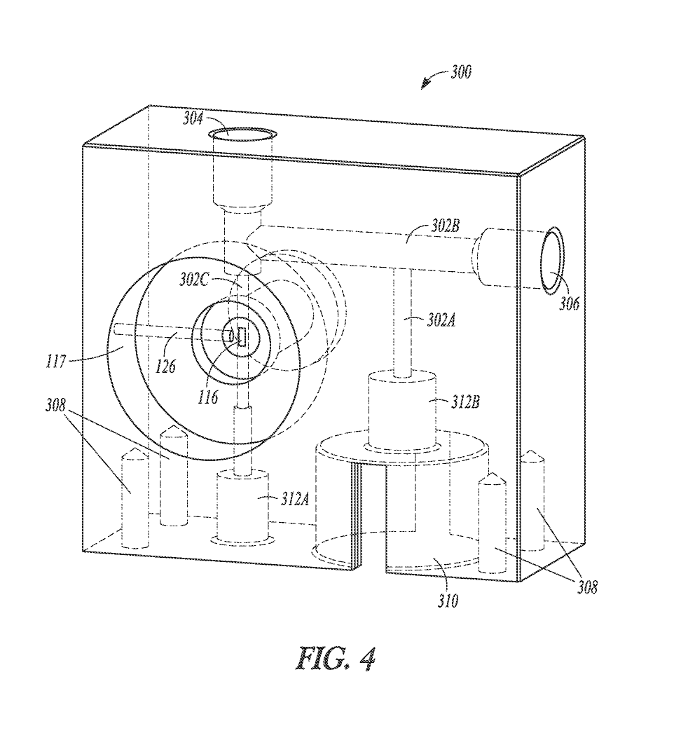

The environmental chamber 100 is pressured with a gas (not shown) that may or may not react with the liquid suspension 106. The environmental chamber 100 may be heated by using sets of cartridge heaters placed in regularly distributed holes in a main body (discussed further below) of the chamber or by encasing the chamber with tightly fitting double-walled plates (not shown) that are temperature-controlled using a liquid circulator to either heat or cool the chamber. A thermocouple placed in a thermocouple well (shown at 126 in FIGS. 3, 4 and 6) near the entry window 114 is used to facilitate both temperature control and temperature measurement.

An important aspect of the environmental chamber 100 is that it allows the study of particles in motion, with these particles dispersed in a liquid, while the liquid suspension may be at near vacuum conditions to pressures to 2000 bars or more at temperatures ranging from −50° C. to 500° C. As the pressurizing media are usually in the form of various gases at high pressures, the liquid 106 will be in equilibrium with these gases even though they may react chemically with these gases. Both pressures and temperatures can be controlled with precision.

The chamber 100 and its entry and exits ports 110 and 112, the windows 114 and 116, the agitator or pump 108, the radiation source 118 and the detector 124 may, in an example embodiment, form part of an apparatus for radiation analysis of a liquid suspension in motion. Under analysis conditions, although it is preferred, it is not strictly necessary that the liquid proceed all the way around the loop 102 driven, by example, by a pump 108. It is merely necessary that the solids in suspension adjacent the windows (i.e. under analysis) be in motion or some degree of agitation. In this case, the motion may be imparted to the solids contained in the liquid suspension by an agitator 108 with the liquid part of the suspension itself remaining essentially static in the loop. The liquid part will nevertheless pass to the solid particles pulses of energy or vibration imparted to the liquid suspension by the agitator. When the solid particles are in motion, either through continuous flow around the loop or during “static agitation” (as it were), they will tend to move, spin and/or roll around while in suspension in the liquid and this continuous movement allows radiation analysis of the solid particles along different crystalline orientations.

An example embodiment of the environmental chamber 100 is now described with reference to FIGS. 3, 4, 5, and 6.

FIG. 3 shows a main unit (or upper part) 300 of the high-pressure environmental chamber 100 and the location of a round entry window 114. Although the dimensions of the chamber are not necessarily important, it is envisaged that the chamber could be miniaturized (and made portable) or enlarged without losing functionality. Great convenience may be provided to an analyst by providing the chamber in portable form such that it may be carried and set up with the other elements of the analytical apparatus (radiation source, detector and so forth) at remote geographic sites. The main unit of the environmental chamber, or the chamber itself, may thus have a width of approximately 85 mm, a height of approximately 76 mm, and a thickness of approximately 38 mm.

One portion of the closed-circuit loop or channel 102 is seen to comprise legs or sections, shown generally at 302A, 302B and 302C. The numerals 302A, 302B and 302C are intended to refer generally to the vertical or horizontal legs or sections of the upper loop which together define a generally inverted U-shaped channel or passage of varying diameter for the liquid suspension 106 in the main unit 300.

Also disclosed in ghosted outline in FIG. 3 are a pressure port 304, an additional inlet/outlet port 306, assembly bolt holes 308, and a well (or recess) 310 to house reciprocating pump solenoids or other electromagnetic pump drive (not shown) for a reciprocating pump, such as pump 108 shown in FIG. 1. Also disclosed in ghosted outline in FIG. 3 is a well 126 to accommodate a thermocouple for temperature measurement/temperature control of the chamber.

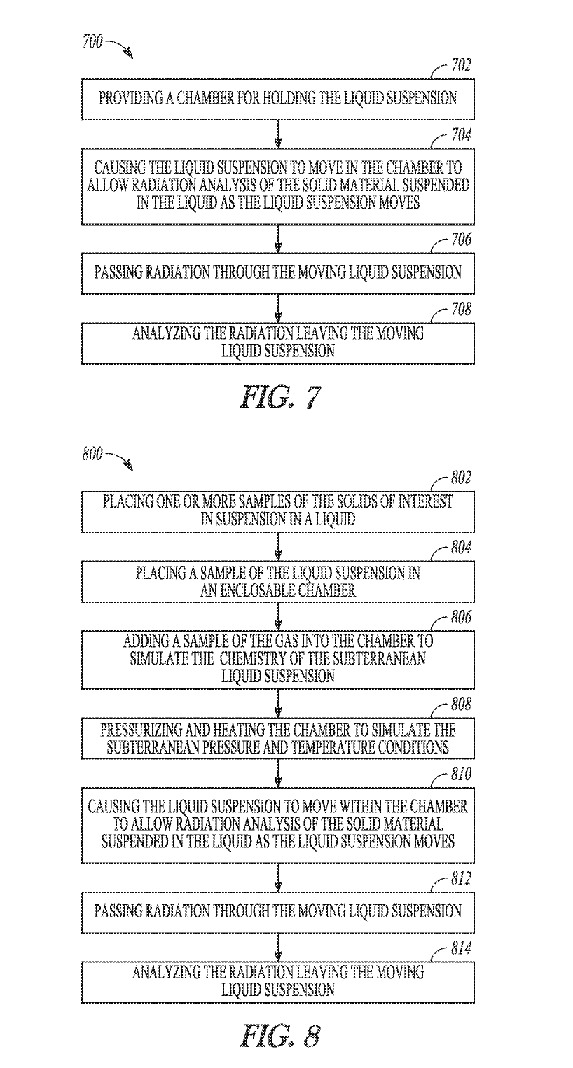

A connection well of cylindrical form is shown at 312A. This well 312A accommodates with a tight fit a connection cylinder (visible at 602 in FIG. 6) described in more detail below. A similar connection well 312B is positioned above the solenoid well 310.

A well for entry of the illuminating beam is shown at 115. This well terminates in the entry window 114, in this case a circular hole that may have a diameter of 1 mm and that may have a depth of 0.25 mm, where it intersects the channel 302C to allow the illuminating beam to radiate the suspension. The well 115 accommodates an entry assemblage (not shown) that may consists of tube with a central hole having a diameter of 1 mm that terminates in a seat that may abut the entry window 114, or include an external entry window 114, for example a 2-mm diamond disk, and a seal that seals the external window against the chamber at the channel 302C. The tube may be attached tightly onto the chamber, using a screw nut for example, to withhold the pressure forces present in the channel leg 302C.

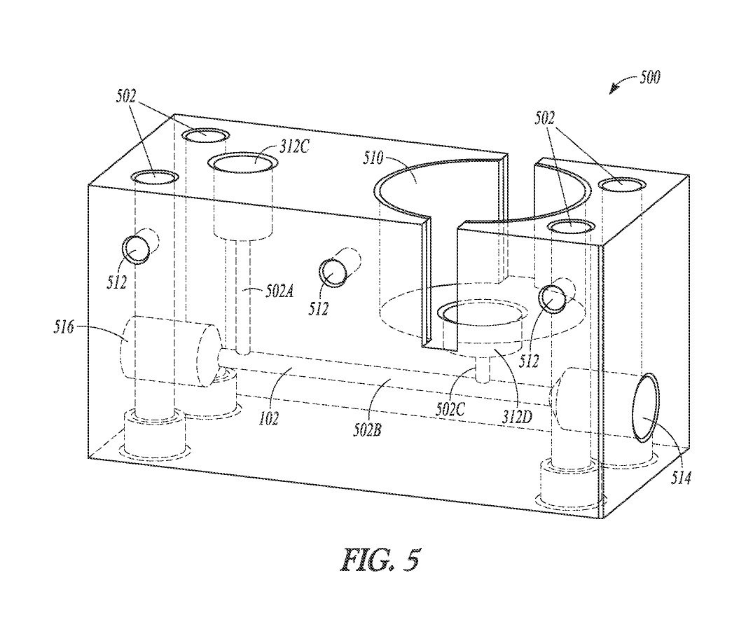

FIG. 4 shows the same main unit 300 shown in FIG. 3 but viewed from the side of the exit window 116. The legs of the upper portion of the closed-circuit loop 102 are again shown generally at 302A, 302B and 302C. The ports 304 and 306, the pump-drive well 310, the connection wells 312A and 312B, the thermocouple well 126, and the bolt holes 308 as described above are again shown in ghosted outline and numbered accordingly.

An exit well for the refracted or diffracted beam 122 (see FIG. 2) is shown at 117. This well 117 is stepped at three different depths and intersects channel 302C to define the exit window 116, in this case a rectangular hole, that may have a width of 1 mm, to allow the exit of the refracted of diffracted beam emanating from the suspension.

The stepped exit well 117 may allow accommodation, in the smallest step, of an external exit window (not shown), for example a 6-mm diamond disk, and a seal, that may seal the window against the chamber. The next step accommodates an intermediate ring (not shown) to confine and support the exit window and seal against the chamber. The last step accommodates a wide ring (not shown) that screws into the chamber body to support the intermediate ring against the pressure present in the channel 302C.

The supporting ring and the wide ring screw may have an outwardly directed cone-shaped central hole that is continuous between the intermediate ring and the wide ring and that allows a wide range of angles for the exit of refracted or diffracted beams 122 (see FIG. 2)

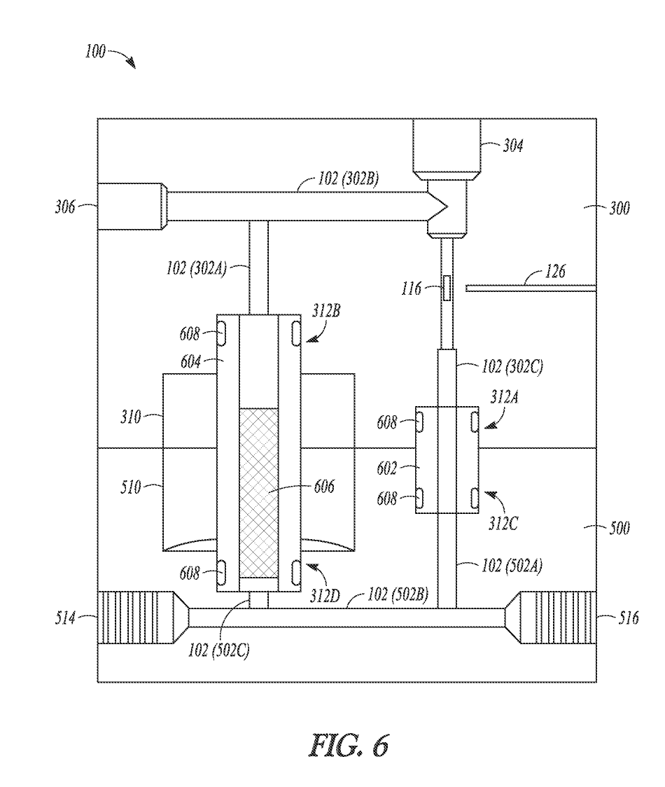

FIG. 5 shows a base unit (or lower part) 500 for the environmental chamber 100 onto which the main unit 300 described above may be bolted. The two units are bolted together using assembly bolts located in bolt holes 502. The bolt holes 502 of the base unit 500 line up with the bolt holes 308 of main unit 300 such that both units can be drawn together and secured by bolts (not shown) to define an assembled environmental chamber comprised in two parts by the base 500 and main 300 units respectively. In such an assembled configuration, the upper portion of the closed circuit loop 102 (made up by legs 302A, 302B and 302C) are brought into fluid communication with a lower portion of the closed circuit loop 102 in the base unit 500. The lower portion of the loop 102 is shown generally by legs 502A, 502B, and 502C. The numerals 502A, 502B and 502C are intended to refer generally to the vertical or horizontal legs or sections of the lower loop which together define a generally U-shaped channel or passage of varying diameter for the liquid suspension in the base unit 500.

The base unit 500 also comprises connection wells 312C and 312D, and a further complementary well 510 to match up with the electromagnetic pump drive well 310. Inlet/outlet ports for the loop 102 are provided at 514 and 516. Base unit mounting holes are present on both sides of the base unit but they are for clarity shown only on one side at 512. These mounting holes are used to mount and align the chamber assembly.

Reference is now made to FIG. 6 which shows a cross-section of the assembled main unit 300 and base unit 500. This view shows the opposed portions of the closed-circuit circulation loop 102 (comprised by legs 302A, 302B, 302C and 502A, 502B and 502C numbered in parenthesis) of the assembled chamber defined, in this example embodiment, by the main unit 300 and the base unit 500.

The closed-circuit loop 102 between both units is completed and sealed by connection cylinders, mentioned above. Here, in this example embodiment, the connection cylinders are seen to comprise one small hollow connection cylinder 602 and one larger hollow connection cylinder 604. The larger connection cylinder 604 accommodates a magnetic piston assembly 606 and check valve (not shown). The hollow cavities of the connection cylinders form part of the closed-circuit loop 102 when assembled in place.

In most cases, O-rings 608 are used for the seals between the connection cylinders and the connection wells in which they sit. However, when the circulating liquid degrades the O-ring material, such as in CO₂—H₂O liquids at elevated pressures and temperatures, PEEK cone seals and PEEK compression seals are excellent replacements. In high-temperature applications, silver compression seals may be used. In order to mount and align the units of the environmental chamber, mounting holes are present, see for example at 512, FIG. 5.

In leg 302C of the closed-circuit loop, the exit window or slot 116 is provided in the main unit 300 to allow passage of refracted or diffracted electromagnetic radiation, X-rays and the like during radiation analysis of the liquid suspension circulating in the loop 102 of the chamber 100.

The environmental chamber has widespread and significant applications, particularly in low-temperature and/or high-pressure mineralogical, geochemical, and bio-geochemical studies, in crystallography, and in chemical and environmental engineering. In addition, the invention has numerous applications in processes involving coal gasification and oil/gas production from tar-sands and oil-shales. An example of an important application is a study involving the sequestration of CO₂ in reservoir rocks in the earth's crust. In such a study, minerals of interest are brought into suspension in a brine and pressurized by CO₂ gas. This environmental chamber as described herein allows the study, in real time, of possible dissolution or alteration reactions of these minerals with CO₂ as well as the possible precipitation of different minerals. This will allow the evaluation whether and how these reactions cause changes in reservoir rocks. This information is important, as these changes may impact on the permeability and/or porosity of the reservoir rocks and cap rocks, as well as the volume of the reservoir rocks or the cap rocks.

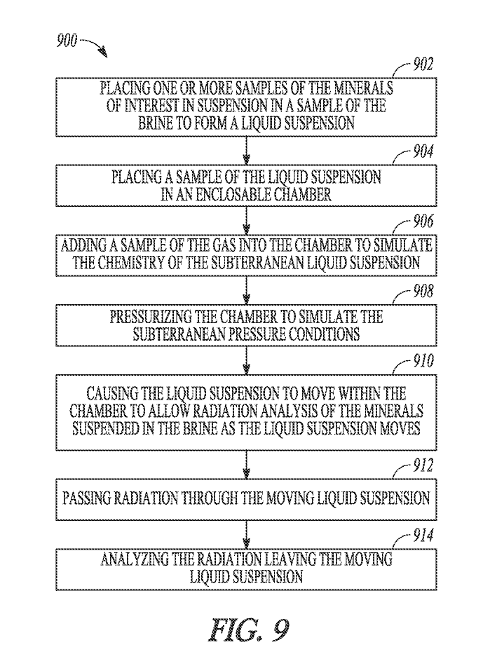

FIGS. 7, 8 and 9 illustrate methods of analysis according to example embodiments of the invention. An apparatus or chamber such as any of those illustrated in FIGS. 1 to 6 may be used to facilitate the example methods. References to “samples” in this specification and the disclosed methods of analysis is intended to refer to replica or made-up samples of the solid materials, liquid suspensions, brines and so forth that exist in subterraneous conditions. It is not strictly necessary that actual samples of such subterraneous materials be used in the disclosed methods of analysis, although such samples could be used.

In FIG. 7, a method 700 of radiation analysis of a liquid suspension may comprise: at block 702, providing a chamber for holding the liquid suspension; at block 704, causing the liquid suspension to move in the chamber to allow radiation analysis of the solid material suspended in the liquid along different crystalline orientations as the liquid suspension moves; at block 706, passing radiation through the moving liquid suspension; and at block 708, analyzing the radiation leaving the moving liquid suspension.

The method may further comprise maintaining the liquid suspension under pressure during radiation analysis. The method may yet further comprise maintaining the liquid suspension at pressures in the range 0-2000 bars, or in excess of 2000 bars, during radiation analysis. The method may further comprise maintaining the liquid suspension at a steady temperature during radiation analysis. The method may further comprise maintaining the liquid suspension at a steady temperature in the range of −50° C. to 500° C. during radiation analysis.

In FIG. 8, a block diagram of method 800 is shown for analyzing, by simulation thereof, the conditions of a dynamic subterranean environment in which solids of interest are placed in suspension in a liquid and are pressurized by a gas at an identified environment temperature. The method 800 may comprise: at block 802, placing one or more samples of the solids of interest in suspension in a liquid; at block 804, placing a sample of the liquid suspension in an enclosable chamber; at block 806, adding a sample of the gas into the chamber to simulate the pressure, temperature and/or gas chemistry of the subterranean liquid suspension; at block 808, pressurizing and heating the chamber to simulate the subterranean pressure and temperature conditions; at block 810, causing the liquid suspension to move within the chamber to allow radiation analysis of the solid material suspended in the liquid along different crystalline orientations as the liquid suspension moves; at block 812, passing radiation through the moving liquid suspension; and at block 814, analyzing the radiation leaving the moving liquid suspension.

In FIG. 9, a block diagram of method 900 is shown for assessing the environmental impact on subterranean rocks containing minerals of interest which are sought to be recovered by being placed in suspension in a brine and pressurized by a gas. The method may comprise: at block 902, placing one or more samples of the minerals of interest in suspension in a sample of the brine to form a liquid suspension; at block 904, placing a sample of the liquid suspension in an enclosable chamber; at block 906, adding a sample of the gas into the chamber to simulate the chemistry of the subterranean liquid suspension; at block 908, pressurizing the chamber to simulate the subterranean pressure conditions; at block 910, causing the liquid suspension to move within the chamber to allow radiation analysis of the minerals suspended in the brine along different crystalline orientations as the liquid suspension moves; at block 912, passing radiation through the moving liquid suspension; and at block 914, analyzing the radiation leaving the moving liquid suspension.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus for radiation analysis of a liquid suspension in motion, the apparatus comprising:
a chamber for holding the liquid suspension;
a port for admission of the liquid suspension into the chamber;
a pump or agitator to move the liquid suspension in the chamber during analysis;
a source of radiation adjacent the chamber;
the chamber having one or more windows through which radiation from the radiation source may pass during radiation analysis of the liquid suspension, and
a detector adjacent the chamber for analyzing radiation leaving the liquid suspension.

2. The apparatus of claim 1, wherein the radiation source permits a radiation analysis of the liquid suspension selected from the group comprising: Raman spectroscopy, Infrared spectroscopy, X-ray diffraction and other photon radiation.

3. The apparatus of claim 1, wherein the chamber is a pressure chamber adapted to maintain the liquid suspension under pressure during radiation analysis.

4. The apparatus of claim 3, wherein the maintained pressure is in the range 0-2000 bars.

5. The apparatus of claim 3, wherein the maintained pressure is in excess of 2000 bars.

6. The apparatus of claim 1, further comprising a pressure port for pressurizing the liquid suspension when the liquid suspension is under radiation analysis.

7. The apparatus of claim 1, wherein the chamber is adapted to maintain the liquid suspension at a steady temperature during radiation analysis.

8. The apparatus of claim 7, wherein the steady temperature is in the range of −50° C. to 500° C.

9. The apparatus of claim 1, further comprising means for heating the liquid suspension when the liquid suspension is under radiation analysis.

10. The apparatus of claim 1, where the chamber defines a closed-circuit loop in which the liquid suspension can move during radiation analysis.

11. The apparatus of claim 10, wherein the pump or agitator is located within the closed-circuit loop.

12. The apparatus of claim 10, wherein the pump or agitator comprises a reciprocating magnetic piston operable to move the liquid suspension within the closed-circuit loop.

13. The apparatus of claim 12, wherein the reciprocating piston is driven by an electromagnetic drive.

14. The apparatus of claim 10, wherein the chamber is comprised of two opposable parts, each part defining a portion of the closed-circuit loop, the parts being joinable together to bring the loop portions into fluid communication with each other and define the closed-circuit loop for the liquid suspension.

15. The apparatus of claim 14, wherein the opposed portions of the closed-circuit loop are joinable together by connection cylinders which seal the closed-circuit loop portions together.

16. The apparatus of claim 1, further comprising one or more ports in fluid communication with the chamber to allow the chemistry of the liquid suspension to be adjusted during analysis.

17. A chamber for radiation analysis of a liquid suspension in motion, the chamber comprising:
an enclosable volume for holding the liquid suspension;
a port for admission of the liquid suspension into the chamber;
a recess for receiving a pump or agitator to move the liquid suspension in the chamber during analysis; and
one or more windows through which radiation may pass during radiation analysis of the liquid suspension.

18. The chamber of claim 17, wherein the chamber is a pressure chamber and the enclosable volume is adapted to maintain the liquid suspension at elevated pressures in the range 0-2000 bars during radiation analysis.

19. The chamber of claim 17, wherein the chamber is a pressure chamber and the enclosable volume is adapted to maintain the liquid suspension at elevated pressures in excess of 2000 bars during radiation analysis.

20. The chamber of claim 17, wherein the enclosable volume is adapted to maintain the liquid suspension at a steady temperature in the range of −50° C. to 500° C. during radiation analysis.

21. The chamber of claim 17, wherein the chamber is portable.

22. A method of radiation analysis of a liquid suspension, the method comprising:
providing a chamber for holding the liquid suspension;
causing the liquid suspension to move in the chamber to allow radiation analysis of the solid material suspended in the liquid as the liquid suspension moves;
passing radiation through the moving liquid suspension; and
analyzing the radiation leaving the moving liquid suspension.

23. The method of claim 22, further comprising maintaining the liquid suspension under pressure during radiation analysis.

24. The method of claim 23, further comprising maintaining the liquid suspension at pressures in the range 0-2000 bars during radiation analysis.

25. The method of claim 23, further comprising maintaining the liquid suspension at pressures in excess of 2000 bars during radiation analysis.

26. The method of claim 22, further comprising maintaining the liquid suspension at a steady temperature during radiation analysis.

27. The method of claim 26, further comprising maintaining the liquid suspension at a steady temperature in the range of −50° C. to 500° C. during radiation analysis.

28. A method of analyzing, by simulation thereof, the conditions of a dynamic subterranean environment in which solids of interest are placed in suspension in a liquid and are pressurized by a gas at an identified environment temperature, the method comprising the steps of:
placing one or more samples of the solids of interest in suspension in a liquid;
placing a sample of the liquid suspension in an enclosable chamber;
adding a sample of the gas into the chamber to simulate the chemistry of the subterranean liquid suspension;
pressurizing and heating the chamber to simulate the subterranean pressure and temperature conditions;
causing the liquid suspension to move within the chamber to allow radiation analysis of the solid material suspended in the liquid as the liquid suspension moves;
passing radiation through the moving liquid suspension; and
analyzing the radiation leaving the moving liquid suspension.

29. A method of assessing the environmental impact on subterranean rocks containing minerals of interest which are sought to be recovered by being placed in liquid suspension in a brine and pressurized by a gas, the method comprising:
placing one or more samples of the minerals of interest in suspension in a sample of the brine to form a liquid suspension;
placing a sample of the liquid suspension in an enclosable chamber;
adding a sample of the gas into the chamber to simulate the chemistry of the subterranean liquid suspension;
pressurizing the chamber to simulate the subterranean pressure conditions;
causing the liquid suspension to move within the chamber to allow radiation analysis of the minerals suspended in the brine as the liquid suspension moves;
passing radiation through the moving liquid suspension; and
analyzing the radiation leaving the moving liquid suspension.
